(19) United States
(12) Patent Application Publication
(10) Pub. No.: US 2026/0052615 A1
(43) Pub. Date: Feb. 19, 2026

(54) DIGITAL ADDRESSABLE LIGHTING INTERFACE CIRCUIT METHOD AND APPARATUS

(71) Applicant: KORRUS, INC., LOS ANGELES, CA (US)

(72) Inventor: JUAN PABLO CASASOLA, Sachse, TX (US)

(21) Appl. No.: 19/370,001

(22) Filed: Oct. 27, 2025

Related U.S. Application Data
(63) Continuation of application No. PCT/US24/26565, filed on Apr. 26, 2024.
(60) Provisional application No. 63/462,102, filed on Apr. 26, 2023.

(51) Int. Cl. H05B 47/18

(52) U.S. Cl. CPC H05B 47/183

(57) ABSTRACT

This disclosure pertains to Digital Addressable Lighting Interface (DALI) circuitry, and particularly, to a DALI bus interface circuit for interfacing a device to a DALI bus.

### FIELD OF THE INVENTION

This disclosure pertains to Digital Addressable Lighting Interface (DALI) circuitry. More particularly, it pertains to a DALI bus interface circuit for interfacing a device to a DALI bus.

### BACKGROUND

DALI or Digital Addressable Lighting Interface is an open, standardized two-way communication protocol for controlling and communicating with components of a lighting system. DALI-based systems may be used for controlling the lighting in a home or business environment, including theatres and concert halls. For instance, a DALI controller may be networked (via the DALI bus) with a plurality of lighting devices and/or sensors so that the controller may be programmed to control the lighting devices, including, for instance, turning lights on or off, dimming lights, etc. The DALI controller also can receive data from the lights, sensors, and other devices via the DALI bus.

FIG. 1 is a block diagram of a basic DALI system. The system comprises at least one DALI controller 103, a DALI power supply 105, and plurality of lighting devices, L1. L2, . . . , Ln. DALI also accommodates other types of devices, such as switches and sensors, but none are shown in FIG. 1 for sake of simplicity. DALI uses a serial two-way bus 101 comprising two lines 101a and 101b, often referred to as Channel 1 and Channel 2. The DALI controller 103 and each lighting device is assigned an address. The devices on the bus, including the DALI controller, any lighting devices, any sensors, any switches, etc., communicate with the other devices on the bus by transmitting binary data over the bus, the binary data typically comprising an address portion identifying the device or devices for which the communication is intended and the actual payload data, such as an instruction from the DALI controller to a lighting device (e.g., turn on to 50% power level), a sensor report from a lighting device or a sensor to the DALI controller (temperature of a light)), a request for data from a device (e.g., Light 1, what is your power level), a report (e.g., Light 1 reports that its current power level is 50%), etc.). The address portion of a message may indicate that it is for one device, multiple devices, or all devices (a broadcast message). Devices that are not identified in the address portion of a message ignore the message. Devices that are identified in the address portion of a message react to the message.

The DALI bus is a current mode communication bus. Thus, a DALI power supply 105 is a current source that provides a constant 250 milliamp (mA) current to the bus with its voltage clamped in a range of 9 volts to 22 volts when idle. One of the bus channels, e.g., 101a is maintained at 9 to 22 volts, and the other is maintained at or near ground. The information on the DALI bus is contained in the current on the bus (not the voltage). In the DALI protocol, a voltage on the bus greater than 9 volts represents a logic one and a voltage on the bus below 4 volts represents a logic zero.

In operation, a device wishing to send a logic zero data bit on a bus essentially electrically shorts the bus to drop the voltage on the bus to at or near zero (although, as noted above, any voltage less than 4 volts will be interpreted as a logic zero). Thus, a requirement of the DALI protocol is that each device must be able to sink up to 250 mA of current. Another requirement of the DALI protocol is that no device on the bus may consume more than 2 mA when idle (idle essentially meaning that it is not transmitting data onto the bus). In addition, the DALI protocol specifies a required slew rate of a transition from a zero to a one and vice versa, including a minimum and a maximum period for transition and that the transition be linear, e.g., 3 μsec≤slew rate≤25 μsec.

When a device is transmitting, the DALI bus carries a current of ˜250 mA, but the voltage is shorted so that the voltage on the bus is near zero. When the DALI bus is idle, the voltage on the bus is between 9 volts and 22 volts, and the current on the bus is the aggregate of all the DALI devices on the bus (each of which must draw no more than 2 mA, as just noted).

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1 is a block diagram of a DALI system in accordance with embodiments;

FIG. 2 is circuit diagram of a cascode circuit for tightly regulating a voltage in the DALI bus interface circuit;

FIG. 3 is a circuit diagram of a DALI bus interface circuit in accordance with an embodiment;

FIG. 4 is a circuit diagram of an exemplary opto-coupler isolation circuit of the prior art;

FIG. 5A is a graph showing the gate to source voltage across transistor Q5 of FIG. 3 as a function of time according to embodiments;

FIG. 5B is a graph showing the voltage on the DALI bus corresponding to the V_{GS} across transistor Q5 shown in FIG. 5A; and

FIG. 5C is a graph showing the current on the DALI bus corresponding to the V_{GS} across transistor Q5 shown in FIG. 5A.

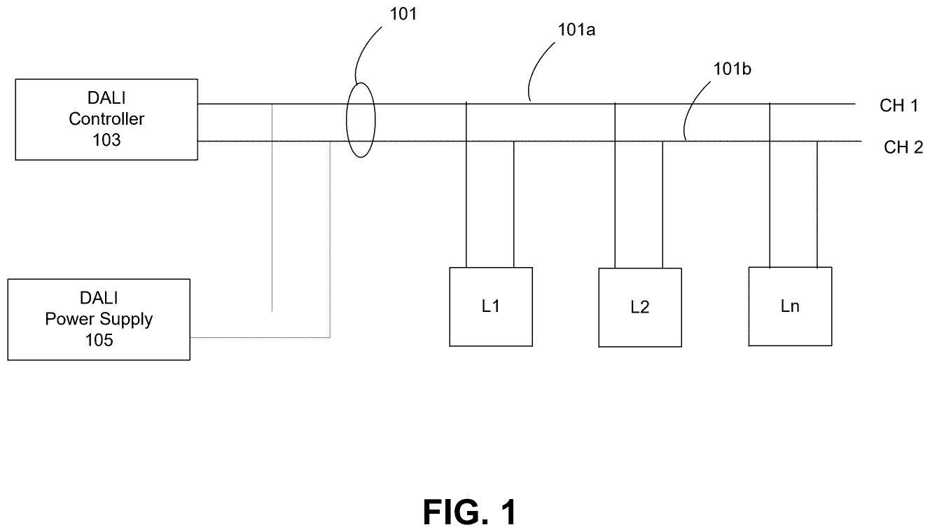

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly, and/or inherently (collectively “provided”) herein.

### Embodiments

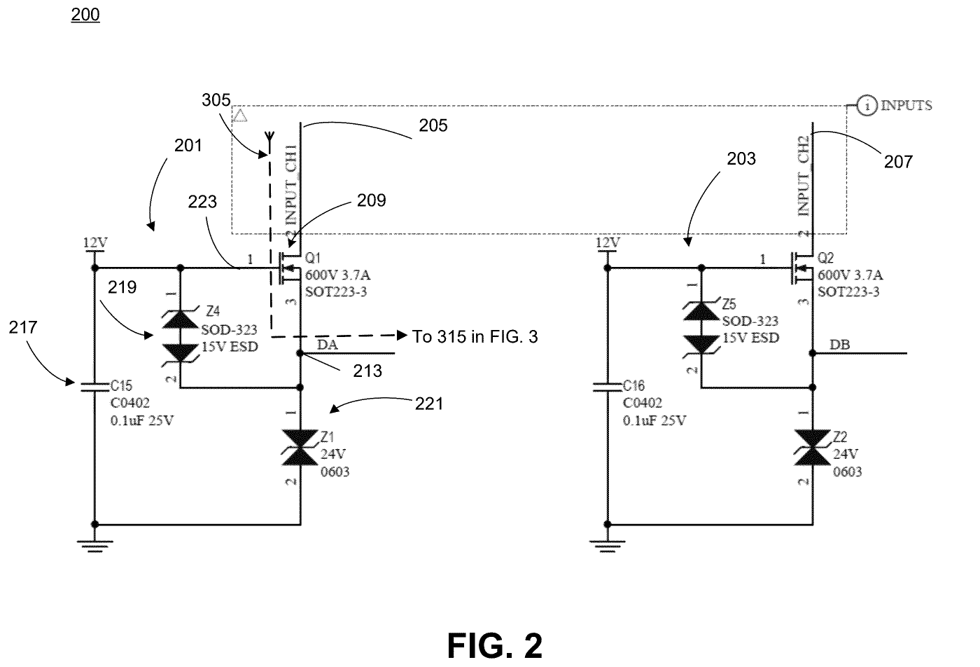

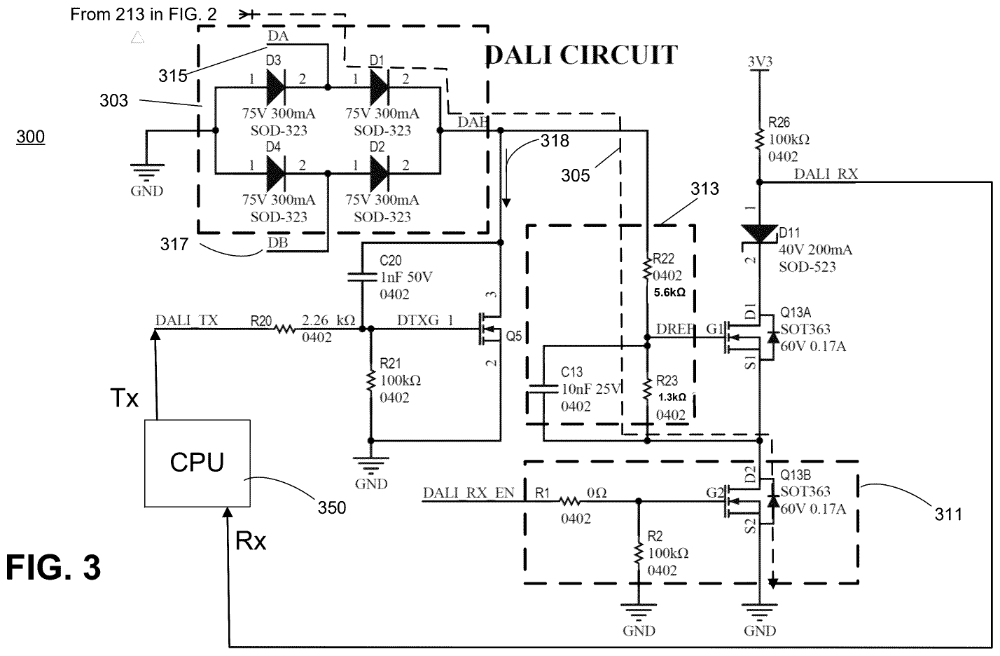

FIG. 2 is a circuit diagram of a protection circuit 200 comprised of two cascodes 201 and 203 that may be employed at the front end of a DALI bus interface circuit in accordance with embodiments, while FIG. 3 is a circuit diagram of a DALI bus interface circuit 300 in accordance with embodiments.

The DALI bus interface circuit 300 (including the voltage regulator front end 200) should be contained in any device that is coupled to the bus, including, for instance, the DALI Controller 103, any lighting device L1 . . . Ln, a sensor, a switch, etc.

In the following discussion, the term “transmit” is used to refer to the situation where any device connected to the bus is transmitting data onto the bus (intended for another device coupled to the bus) and the term “receive” is used to refer to the situation where any device on the bus is receiving data from the bus (data that was transmitted by another device coupled to the bus).

The protection circuit 200 of FIG. 2 may be provided at the front end of the DALI bus interface circuit 300 (i.e., between the DALI bus interface circuit 300 of FIG. 3 and the DALI bus 101 in order to provide voltage protection for the DALI bus interface circuit 300 from voltage variations on the DALI bus. Protection circuit 200 essentially comprises two cascodes 201, 203. Particularly, these cascodes will supply a tightly controlled maximum voltage (e.g., 12 volts maximum) when the voltage on the bus is anyway at or above 12 volts.

More particularly, node 205 of cascode 201 will be coupled to one of the two lines 101a or 101b of the DALI bus 101 while node 207 of cascode 203 will be coupled to the other of the two lines 101b or 101a of the DALI bus 101. For this discussion, we shall assume that node 205 is coupled to bus line 101a, that line 101a (CH 1) is the positive voltage line and that node 207 is coupled to bus line 101b and that line 101b is the common line (e.g., 0 volts). As previously noted, any voltage on line 101a below 4 volts on line 101a is considered a logic zero by the devices on the bus and any voltage above 9 volts on the bus is considered a logic one by the devices on the bus. However, the voltage on the bus may be as high as 22 volts.

For reasons that will be discussed below, in embodiments, it is desirable to control any version of the DALI bus voltage at a node in the DALI bus interface circuit 300 (FIG. 3) at or below a certain maximum voltage (e.g., 12 volts) regardless of the actual voltage on the DALI bus. This function is performed by the cascode circuits of FIG. 2.

More particularly, the two cascode circuits 201 and 203 are essentially identical. Accordingly, only cascode 201 will be discussed as an example, with the understanding that the other cascode 203 operates essentially identically. In short, as is well known, a cascode circuit uses a transistor, e.g., transistor 209, and a feedback loop comprised of a capacitor 217 and the two diode pairs 219 and 221 configured as shown to maintain the voltage at the drain terminal 213 of the transistor (the node labelled DA in FIGS. 2 and 3) at a constant voltage (that voltage being determined primarily by the value of the capacitor 217 and the voltage supplied at the gate terminal 223 of the transistor 209.

In this particular embodiment, the voltage supplied at the gate terminal is 12 volts, the capacitor 217 is a 1 microfarad, 25 volt capacitor, the transistor is a 600 volt, 3.7 Amp MOSFET transistor, the first diode pair 219 comprises two low capacitance Electrostatic Discharge (ESD) diodes (SOD-323 15V ESD) oriented anode to anode, and the second diode pair comprises two diodes (Z1 24V 0603) oriented cathode to cathode. The first current flow terminal (e.g., the drain terminal) of the transistor, Q1, is coupled to one of the bus channels, and the second current flow terminal (e.g., the source) of the transistor Q1 is coupled to the bus interface node of the interface circuit, I.e., DA or DB. The control terminal (e.g., the gate terminal) of transistor Q1 is coupled to a 12 volt rail.

This will allow the voltage at node DA 213 to track the voltage on the DALI bus when the voltage on the DALI bus is at or below 12V, but will cap the voltage at node DA at 12 volts whenever the voltage on bus line is above 12 volts. Thus, for example, if 0 volts is supplied from the bus at node 205, then the voltage at node DA will be maintained at 0 volts.

Cascode 203 is essentially identical to cascode 201 and will operate essentially identically. Only one cascode 201 or 203 will function as described above in any given implementation because one of the bus lines will be coupled to ground and thus cannot exceed 12 volts. However, the DALI protocol requires that devices be polarity agnostic, which is why a cascode is provided for each bus line, i.e., so that either one of lines 101a and 101b can be the positive voltage bus line. Thus either cascode may be coupled to the higher voltage bus line (9 to 22 volts) with the other being coupled to the lower voltage bus line (e.g., 0 volts) and the operation will be the same except that the polarity will be reversed.

FIG. 3 is a circuit diagram of a DALI bus interface circuit 300 in accordance with an embodiment. Note that the DA node of cascode 201 is coupled to node 315 of the DALI bus interface circuit, and node DB of cascode 203 is coupled to node 317 of the DALI bus interface circuit in this example embodiment. Thus, in this example embodiment, in which we are assuming that bus line 101a is the higher voltage line, then the voltage at node 315 will be a regulated voltage that cannot exceed 12 volts regardless of the actual voltage on DALI bus line 101a (and the voltage at node 317 will be at or near 0 volts).

A bridge configuration 303 also is provided so that the DALI bus interface circuit 300 is polarity agnostic, i.e., regardless of whether DA or DB corresponds to the higher voltage line of the DALI bus, a representation of that voltage not to exceed 12 volts is presented to the DALI interface circuitry at node DAB in FIG. 3. If it were not necessary for the circuit to be polarity agnostic, then the diode bridge circuitry 303 could be eliminated such that the higher voltage one of DA and DB is coupled directly to node DAB, and the other one of DA and DB is coupled directly to ground.

In operation, the voltage at node DAB will be tightly maintained at the voltage on the DALI bus line 101a if the voltage on line 101a is below 12 volts, and to be 12 volts if the voltage on line 101a is greater than 12 volts (actually 12 volts minus the voltage drop across one of the diodes, D1 or D2).

The current path from the DALI Rx bus line 205 (FIG. 2) through the cascode circuit 201 (FIG. 2) and the bus interface circuitry 300 (FIG. 3) when the controller is idle is shown by dashed line 305 appearing in FIGS. 2 and 3. The current passes from node DAB through a resistor ladder 313 (discussed further below), through the source and drain terminals of transistor Q13B of switch 311 (also discussed further below) to ground (and, from ground, back to the other channel of the bus, DB, through diode D4 and cascode 203). The current through that path during idle is maintained at about 1.53 mA, which value is dictated by the aforementioned maximum 12 volts (minus the voltage drop of about 1.4 volts across two of the diodes, e.g., D1 and D4 in this example) maintained at node DAB and the values of resistors R22 and R23. In this embodiment, resistor R22 is a 5.6 kΩ (kilo-ohm) resistor and resistor R23 is a 1.3 kΩ. Thus, with 12−1.4=10.6 volts at node DAB, the current through the node DAB is given by:

$$( 12 - 1.4 volts / ( 5.6 k Ω + 1.3 k Ω ) = 1.53 mA$$

Thus, the DALI bus interface circuit 300 assures that the current draw from the DALI Tx bus line is non-zero, but is maintained below the requires 2 mA during idle. More particularly, as previously noted, because the DALI bus is a current mode bus, in order for the DALI controller to operate on the DALI bus, it must draw a current at all times, including while idle (must be greater than zero, but less than 2 mA during idle). That is why the DALI bus interface circuitry 300 is designed to draw about 1.53 mA during idle.

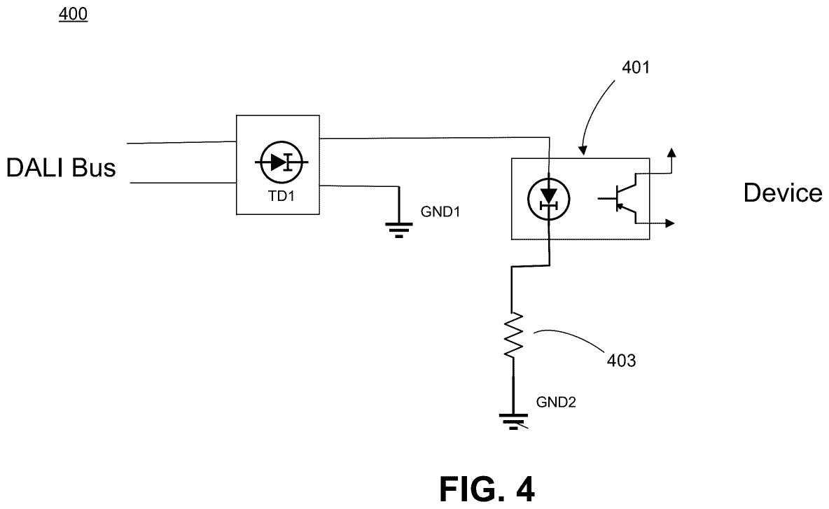

This design is advantageous because it maintains the idle mode current at about 1 mA (depending on the exact voltage on the DALI bus) in a much more cost-effective and durable manner than traditional designs, such as employing an isolation circuit such as shown in FIG. 4, comprising an opto-coupler 401 and resistor 403 for each bus line. More particularly, this design eliminates the opto-coupler, which is a much more costly device than a pair of resistors. Furthermore, opto-couplers tend to degrade relatively quickly as compared to resistors. Hence, in addition to being less costly, the present design also should operate effectively for a much longer time than traditional designs.

Switch 311 is optional insofar as it is a switch for selectively enabling or disabling the DALI controller bus interface circuit 300 with respect to the DALI bus. More particularly, in some implementations, a device may be designed to be multi-modal, i.e., designed to operate in accordance with the DALI protocol as well as in other protocols or environments (e.g., DMX, 10 volt, etc.). In some of those other environments (e.g., voltage mode environments), it may not be necessary to draw any current during idle, in which case, instead of operating according to the description above, the circuit 300 may be simply disabled during idle by turning off switch 311 by turning off the DALI Rx Enable control signal into the switch 311.

In devices that are strictly intended for interfacing only with a DALI bus, switch 311 may be eliminated.

Turning now to active operation, the nodes labelled DALI RX and DALI TX are coupled to a Central Processing Unit (CPU) 350 (or similar processing circuitry that comprises the brains of the device), whether the device be a DALI controller 103, lighting device, sensor, etc.). The CPU 350 receives data from the DALI bus (e.g., from other devices connected to the DALI bus) via the DALI RX node and transmits data out onto the bus (e.g., intended for other devices connected to the DALI bus) via the DALI TX node.

Unlike the DALI bus, which is a current mode bus, a CPU typically is a voltage mode device, i.e., the CPU interprets voltages (not currents) as either a logic one or a logic zero (in the particular embodiment discussed in connection with FIGS. 2 and 3, e.g., 3.3 volts represents a logic zero and 0 volts represents a logic one). As noted previously, in the example embodiments discussed herein, when another device has placed a logic one on the bus, the voltage on the bus will be 9-22 volts and the current on the bus to be at or near 250 mA. Also as previously described, this condition on the bus will cause a current of about 1.53 mA to run through node DAB to ground through the receive path 305. Also, note that the CPU 350 turns off the transmit path (i.e., from DALI Tx through transistor Q5 to node DAB) when in idle so no current runs down leg 318 (e.g., by placing 0 volts at the DALI TX node, which is connected, through resistor R20, to the gate of transistor Q5, thereby turning transistor Q5 off).

Thus, when in idle mode (i.e., when receiving data over the bus or, at least, not transmitting on the bus), a 1.53 mA current at node DAB must be converted to a voltage of 0 volts at the DALI Rx node (which is the receive port into the CPU 350) so that the CPU interprets it as a logic one.

On the other hand, when a device is transmitting a logic zero on the bus, there will be essentially no current on the bus, and thus essentially 0 mA of current and 0 volts at node DAB. This, when in idle mode, this condition (i.e., 0 mA and 0 volts at node DAB) must be converted to 3.3 volts at the DALI RX node into the CPU 350 that the CPU interprets it as a logic zero.

Thus, this current to voltage conversion in the receive path of DALI interface circuit 300 is performed by a current to voltage converter comprised of transistor Q13A and resistor R26 (diode D11 is optional and discussed further below). More particularly, the source terminal of transistor Q13A is coupled to the DALI RX node. The DALI RX node also is coupled to a 3.3 volt rail through a very high impedance resistor R26 (e.g., 100 kΩ). The drain terminal of transistor Q13A is coupled to ground (either directly or through optional switch 311, as previously discussed). For purposes of this discussion, the switch 311 may be considered to be on, and thus, the drain of transistor Q13A is effectively coupled to ground. The gate of transistor Q13A is coupled between the 5.6 kΩ resistor R22 and the 1.3 kΩ resistor R23. Thus, these two resistors form a resistor ladder voltage divider 313 that will provide a voltage of approximately 2.0 volts at the gate of transistor Q13A when node DAB is at 10.6 volts with 1.53 mA running through it, thereby turning transistor Q13A on. On the other hand, when there is a logic zero on the DALI bus (i.e., 0 volts and 0 mA at node DAB, the voltage at the gate of transistor Q13A will be zero volts, thereby turning transistor Q13A off.

When transistor Q13A is on (meaning a logic one is on the DALI bus), it conducts current to ground from the 3.3 volts rail through high impedance resistor R26 (and diode D11), effectively making the voltage at the DALI RX node 0 volts (which the CPU interprets as a logic 1).

On the other hand, when 0 mA is running through node DAB, transistor Q13A is off, thereby open circuiting the path from the 3.3 volt rail to ground and causing the voltage at the DALI RX node to rise to the rail voltage of 3.3 volts. which represents a logic zero to the CPU.

A capacitor C13 may be provided in voltage divider 313 to form a simple low-pass filter with resistor R23. This may be useful because, in operation, the DALI bus may have high frequency noise on it. In addition, depending on the quality of the other devices on the bus and local environmental factors, the transitions between logic one and logic zero (and vice versa) also may have high frequency components. The RC filter of capacitor C13 and resistor R23 can filter out such high frequency noise.

Also, diode D11 may be provided between transistor Q13A and the DALI RX node to block errant current from affecting the voltage at the DALI RX node. For instance, when switch 311 is off, the drain terminal of transistor Q13A will see the same voltage that is on node DAB (since there is no current running through the voltage divider 313). Since that voltage could be greater than the 3.3 volts at the supply rail, transistor Q13A could conduct electricity through its body diode up to diode D11. Diode D11 will prevent any such current from reaching the DALI RX node.

Turning now to the transmit side, the DALI bus interface circuit 300 should operate such that a signal of 3.3 volts placed on the DALI TX node by CPU 350 (a logic zero for the CPU) should short the DALI bus (which means that the DALI bus interface circuit 300 would have to sink up to 250 mA of current from the bus through node DAB in order to keep the current on the bus running and the voltage on bus line 101a at 0 volts (i.e., which is a logic zero on the DALI bus).

On the other hand, a signal of 0 volts placed on the DALI TX node by CPU 350 (i.e., a logic one for CPU 350) should cause no current to run through the DALI bus, thereby dropping the current on bus line 101a to near zero and causing the voltage on the bus to go to 9-22 volts (i.e., a logic one on the DALI bus).

As can be seen in FIG. 3, the DALI TX node is coupled through 2.26 kΩ resistor R20 to the gate of transistor Q5. When the voltage at node DALI TX transitions from 0 volts to 3.3 volts (a logic zero being output by CPU 350), transistor Q5 is turned on, thus connecting node DAB (which is the voltage-regulated bus current node) to ground through the source and drain terminals of the transistor Q5. Thus, when transistor Q5 is turned on, the DALI bus interface circuit 300 draws the full current on the bus (e.g., up to 250 mA) to ground, which any receiving devices on the bus will interpret as a logic zero.

On the other hand, when the voltage at node DALI TX is 0 volts, transistor Q5 is turned off, thus eliminating the current path from node DAB (and, consequently, from the DALI bus) to ground. In this condition, the only current path in the DALI bus interface circuit 300 for the DALI bus current is aforementioned 1.53 mA path 305. Thus, when transistor Q5 is turned off, the DALI bus interface circuit 300 draws only about 1.53 mA of current from the bus. With all of the other devices on the DALI bus drawing less than 2 mA, the current on the DALI bus will be very low, which the devices on the bus will interpret as a logic one.

A 100 kΩ resistor R21 may be employed between the gate terminal of transistor Q5 and ground as a pull down resistor to default the gate of transistor Q5 to 0 volts in order to keep the transistor off during abnormal operating points when the CPU is not operating (e.g., during power up or power down of the controller circuit 103).

Furthermore, an RC circuit comprised of 2.26 kΩ resistor R20 and 1 nanofarad capacitor C20 acts as a filter that provides a negative feedback loop for transistor Q5 when it is in the active transistor region between its on state (saturation region) and off state (cutoff region). The feedback loop controls the slew rate of the transitioning of the transistor Q5 between on and off states, with the slew rate dictated by the values of resistor R20 and capacitor C20.

More particularly, as previously noted, the DALI bus protocol specification requires that the slew rate of the transition between logic one and logic zero on the bus be linear and within specific minimum and maximum tolerances, e.g. 3 μsec≤slew rate≤25 μsec.

In operation, when the CPU tries to turn on transistor Q5 (by placing 3.3 volts at node DALI TX to increase the gate-to-source voltage, Vos, above the threshold voltage to turn the transistor on), the transistor Q5 starts to turn on. This will cause the voltage at the source terminal of the transistor (which is the voltage at node DAB) to start to drop. Particularly, a transistor that is on allows current to flow freely from its source terminal to its drain terminal, thereby bringing the voltage at the source terminal to the same voltage at the drain terminal. Since the drain terminal is coupled to ground, this will drop the voltage at the DAB node to ground. However, as the voltage at the source terminal drops, capacitor C20, which is coupled between node DAB and the gate terminal of the transistor Q5 will simultaneously start to pull down the voltage at the gate of transistor Q5, thus reducing V_{GS} and tending toward turning the transistor back off. With capacitor C20 and resistor R20 set to the proper values, the gate-to-source voltage of transistor Q5 can be held relatively constant near the threshold voltage of the transistor and the voltage at the gate terminal of the transistor Q5 is held relatively constant, (e.g., at 1 volt). With the voltage at the gate terminal of transistor Q5 held constant (e.g. at about 1 volt) and the voltage at the DALI RX node held constant (e.g., at 3.3 volts) by the CPU, a constant current flows through resistor R20 to the bottom of capacitor C20, thereby charging capacitor C20 linearly until capacitor C20 is sufficiently charged to make the gate to source voltage of transistor Q5 turn the transistor fully on (completing the transition of transistor Q5 from off to on).

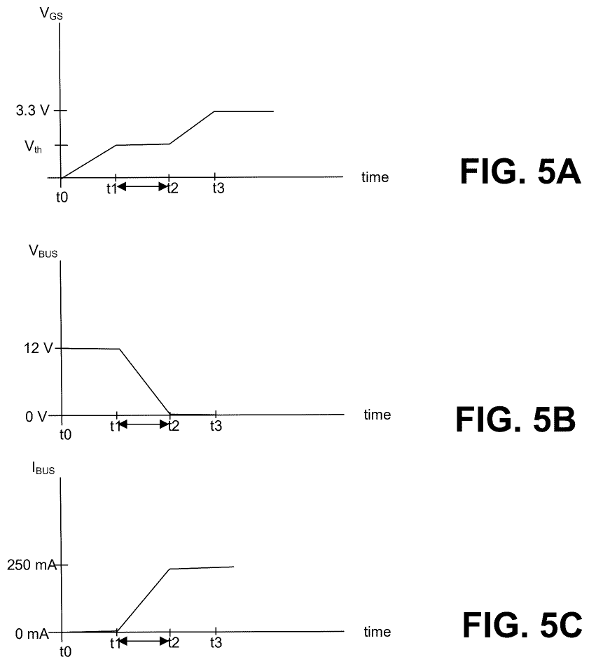

FIGS. 5A, 5B, and 5C, respectively, are (1) a graph showing the Ves across transistor Q5 as a function of time according to the operation described above, (2) a graph showing the corresponding voltage on the DALI bus as a function of time according to the operation described above, and (3) a graph showing the corresponding current on the DALI bus as a function of time according to the operation described above. As shown in FIG. 5A, when the CPU places 3.3 volts on the DALI TX node at time t0, the gate to source voltage at transistor Q5 starts to rise as seen over time t0 to t1. Then, the negative feedback loop becomes the dominant effect, causing the gate to source voltage of transistor Q5 to remain near the threshold voltage of the transistor from time t1 to t2. At time t2, the charging of the capacitor C20 takes over and starts to pull the gate to source voltage of transistor Q5 up to 3.3 volts. The voltage at the gate of transistor Q5 reaches steady state at 3.3 volts at time t3. The period from t1 to t2 is the period during which the transistor is linearly transitioning from off to on and thus defines the slew rate of the transition on the bus from logic zero to logic one.

As shown in FIGS. 5B and 5C, respectively, the DALI bus experiences a corresponding linear voltage transition from 12 volts to 0 volts and a corresponding linear current transition from 250 mA to 1 mA over time t1 to t2.

The circuit essentially operates in the inverse fashion when transistor Q5 transitions from the on state to the off state.

Thus, in short, because of the constant current through resistor R20, capacitor C20 charges very linearly and at a rate easily and precisely set by the values of resistor R20 and capacitor C20, thereby very precisely and linearly controlling the slew rate of transitions on the bus between logic one and logic zero and vice versa.

### Synopsis

In summary, the aforedescribed DALI bus interface circuit is an inexpensive circuit that can precisely and linearly control the slew rates between logic one and logic zero and vice versa on a DALI bus with very reliable, durable, and inexpensive circuit components.

Furthermore, a cascode circuit is used as a voltage regulator to very precisely maintain no greater than a particular voltage (e.g., 12 volts) at the DAB bus interface node of the DALI bus interface circuit 300 when the voltage on the actual DALI bus exceeds 12 volts. This precise voltage at the DAB node, in turn, both (1) allows for accurately controlling the idle current draw of the device from the DALI bus using only an inexpensive resistor ladder 313 and (2) permits an inexpensive current to voltage conversion using a single transistor (Q13A) for converting current to voltage between the current mode DALI bus and the voltage mode CPU.

Additionally, on the transmit leg of the DALI controller, the slew rate for transitions between logic zero and logic one and vice versa are precisely and linearly controlled with the use of an inexpensive, reliable, and durable RC circuit with low power dissipation, rather than a more expensive, more power hungry, less reliable, and less durable opto-coupler.

In short, the DALI bus interface circuit embodiments disclosed herein are very inexpensive, have very tight tolerances, are very reliable, and are very durable.

### CONCLUSION

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of circuit diagrams, block diagrams, flowcharts, and/or examples. Insofar as such circuit diagrams, block diagrams, flowcharts, and/or examples contain one or more functions and/or operations, it will be understood by those within the art that each function and/or operation within such circuit diagrams, block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

1. A circuit for interfacing a device to a Digital Addressable Lighting Interface (DALI) bus, the DALI bus comprising a first channel and a second channel, the circuit for interfacing comprising:
a cascode circuit coupled between the DALI bus and a bus interface node of a DALI bus interface circuit, the cascode circuit configured to present a voltage at the bus interface node that tracks the voltage on the DALI interface bus up to a predetermined maximum voltage and to present the predetermined maximum voltage at the bus interface terminal when the voltage on the DALI bus exceeds the predetermined maximum voltage;
a voltage ladder circuit coupled between the bus interface node and ground, the voltage ladder comprising a first voltage ladder resistor and a second voltage ladder resistor coupled in series between the bus interface node and ground; and
a first transistor having a control terminal coupled to a node between the first voltage ladder resistor and the second voltage ladder resistor, a second current flow terminal coupled to ground, and a second current flow terminal coupled to an input node, the input node for coupling to a voltage mode processing device for receiving data from the DALI bus.

2. The circuit of claim 1 wherein the cascode circuit comprises:
a second transistor having a first current flow terminal coupled to the first channel of the DALI bus, a second current flow terminal coupled to the bus interface terminal, and a control terminal coupled to a first constant voltage source at the predetermined maximum voltage;
an anode-to-anode-coupled diode pair coupled between the control terminal of the first transistor and the second current flow terminal of the first transistor; and
a cathode-to-cathode-coupled diode pair coupled between the second current flow terminal of the second transistor and a ground.

3. The circuit of claim 2 wherein the cascode circuit further comprises:
a first capacitor coupled between the voltage rail and ground.

4. The circuit of claim 1 further comprising
a third resistor coupled between a second constant voltage source and the input node.

5. The circuit of claim 5 wherein the third resistor has a resistance adapted to cause a voltage at the input node to be close to zero volts when the second transistor is on.

6. The circuit of claim 4 further comprising:
a diode having an anode terminal coupled to the input node and a cathode terminal coupled to the second current flow terminal of the first transistor.

7. The circuit of claim 1 further comprising:
a second capacitor coupled in series with the second voltage ladder capacitor.

8. The circuit of claim 1 further comprising:
a third transistor having a first current flow terminal coupled to the bus interface node, a second current flow terminal coupled to ground and a control terminal for coupling to an output terminal coupled to an output terminal for coupling to the processing device for receiving data for placement on the DALI bus.

9. The circuit of claim 8 further comprising:
a third capacitor coupled between the first current flow terminal and the control terminal of the third transistor; and
a fourth resistor coupled between the control terminal of the third transistor and the output node.

10. The circuit of claim 9 wherein the capacitance value of the third capacitor and the resistance value of the fourth resistor are configured relative to one another to form a feedback loop that causes the third transistor to remain in its active region for a predetermined period of time when a signal placed at the output terminal is transitioning between a first logic state and a second logic state.

11. The circuit of claim 10 wherein the capacitance value of the third capacitor and the resistance value of the fourth resistor are configured relative to one another to cause a slew rate of the third transistor between on and off states to be linear and of a predetermined period.

12. The circuit of claim 11 wherein the predetermined slew rate period of between 3 μsec and 25 μsec.

13. The circuit of claim 10 further comprising:
a fifth resistor coupled between the control terminal and the second current flow terminal of the third transistor.

14. A circuit for interfacing a device to a Digital Addressable Lighting Interface (DALI) bus, the DALI bus comprising a first channel and a second channel, the circuit for interfacing comprising:
a cascode circuit coupled between the DALI bus and a bus interface node of a DALI bus interface circuit, the cascode circuit configured to present a voltage at the bus interface node that tracks the voltage on the DALI interface bus up to a predetermined maximum voltage and to present the predetermined maximum voltage at the bus interface terminal when the voltage on the DALI bus exceeds the predetermined maximum voltage; and
a transistor having a first current flow terminal coupled to the bus interface node, a second current flow terminal coupled to ground and a control terminal for coupling to an output terminal coupled to an output terminal for coupling to the processing device for receiving data for placement on the DALI bus.

15. The circuit of claim 14 further comprising:
a capacitor coupled between the first current flow terminal and the control terminal of the transistor; and
a first resistor coupled between the control terminal of the transistor and the output node.

16. The circuit of claim 15 wherein the capacitance value of the capacitor and the resistance value of the first resistor are configured relative to one another to form a feedback loop that causes the transistor to remain in its active region for a predetermined period of time when a signal placed at the output terminal is transitioning between a first logic state and a second logic state.

17. The circuit of claim 10 wherein the capacitance value of the capacitor and the resistance value of the first resistor are configured relative to one another to cause a slew rate of the transistor between on and off states to be linear and of a predetermined period.

18. The circuit of claim 17 wherein the predetermined slew rate period of between 3 μsec and 25 μsec.

19. The circuit of claim 18 further comprising:
a second resistor coupled between the control terminal and the second current flow terminal of the transistor.
